(19) United States
(12) Patent Application Publication
(10) Pub. No.: US 2025/0329199 A1
(43) Pub. Date: Oct. 23, 2025

(54) INFORMATION PROCESSING DEVICE

(71) Applicant: TOYOTA JIDOSHA KABUSHIKI KAISHA, Toyota-shi (JP)

(72) Inventors: Yasuaki NADAYA, Toyota-shi (JP); Manabu MATSUYAMA, Toyota-shi (JP); Akihiro YATSUZUKA, Yaizu-shi (JP)

(73) Assignee: TOYOTA JIDOSHA KABUSHIKI KAISHA, Toyota-shi (JP)

(21) Appl. No.: 19/078,332

(22) Filed: Mar. 13, 2025

(30) Foreign Application Priority Data
Apr. 17, 2024 (JP) 2024-066566

(51) Int. Cl. G07C 5/08

(52) U.S. Cl. CPC G07C 5/0825

(57) ABSTRACT

An information processing device includes a processor configured to: cause a display to display a meter image of a meter that indicates vehicle information relating to travel control of a vehicle; and change an interval of graduations of the meter illustrated in the meter image, in accordance with a state of the vehicle.

### CROSS-REFERENCE TO RELATED APPLICATION

This application is based on and claims priority under 35 USC 119 from Japanese Patent Application No. 2024-066566 filed on Apr. 17, 2024, the disclosure of which is incorporated by reference herein.

### TECHNICAL FIELD

The present disclosure relates to an information processing device.

### RELATED ART

Japanese Patent Application Laid-Open (JP-A) No. 2010-266288 discloses a technique in which an entire image of a speedometer is displayed at a display so as to increase a display magnification of a number and a graduation close to an instructed value instructed by a pointer.

### SUMMARY

### Problem to be Solved by the Invention

However, in the technology described in Japanese Patent Application Laid-Open (JP-A) No. 2010-266288, in accordance with a change in vehicle speed, an area in which the display magnification increases in the entire image of the speedometer constantly changes, and the display content of the display becomes troublesome for the driver.

Accordingly, an object of the present disclosure is to provide an information processing device capable of improving the visibility of a meter image of a meter, displayed at a display, which indicates vehicle information relating to travel control of a vehicle.

### Means for Solving the Problem

An information processing device of a first aspect includes a control section that is configured to: cause a display to display a meter image of a meter that indicates vehicle information relating to travel control of a vehicle; and change an interval of graduations of the meter illustrated in the meter image, in accordance with a state of the vehicle.

In the information processing device of the first aspect, the control section is configured to cause a display to display a meter image of a meter that indicates vehicle information relating to travel control of a vehicle. Further, the control section is configured to change an interval of graduations of the meter illustrated in the meter image in accordance with a state of the vehicle. This enables the information processing device to increase the visibility of the meter image in a specific state by causing display of the graduations at intervals corresponding to the state of the vehicle.

An information processing device of a second aspect is the information processing device of the first aspect, wherein: the vehicle information is an engine speed; and in a case in which the vehicle is in a sports mode in which travel control suitable for sports travel is performed, the control section is configured to, in the meter image, widen an interval of graduations in a high rotation range of the engine speed to be wider than an interval of graduations in a low rotation range of the engine speed.

In the information processing device of the second aspect, the vehicle information is the engine speed. Moreover, in a case in which the vehicle is in a sports mode in which travel control suitable for sports travel is performed, the control section is configured to widen, in the meter image, the interval of the graduations in the high rotation range of the engine speed to be wider than the interval of the graduations in the low rotation range of the engine speed. This enables the information processing device to increase the visibility of the meter image in the sports mode by widening the interval of the graduations corresponding to the high rotation range which a driver monitors during sports travel.

An information processing device of a third aspect is the information processing device of the first aspect or the second aspect, wherein: the vehicle information is an engine speed; and in a case in which the vehicle is located at a specific location at which sports travel is possible, the control section is configured to, in the meter image, widen an interval of graduations in a high rotation range of the engine speed to be wider than an interval of graduations in a low rotation range of the engine speed.

In the information processing device of the third aspect, the vehicle information is the engine speed. Moreover, in a case in which the vehicle is located at a specific location at which sports travel is possible, the control section is configured to, in the meter image, widen the interval of the graduations in the high rotation range of the engine speed to be wider than the interval of the graduations in the low rotation range of the engine speed. This enables the information processing device to increase the visibility of the meter image at a specific location by automatically widening the interval of the graduations corresponding to the high rotation range in response to the intention of the driver.

An information processing device of a fourth aspect is the information processing device of any of the first aspect to the third aspect, wherein: the vehicle information is an engine speed; and in a case in which the vehicle is in an eco mode in which travel control suitable for eco travel is performed, the control section is configured to, in the meter image, widen an interval of graduations in a low rotation range of the engine speed to be wider than an interval of graduations in a high rotation range of the engine speed.

In the information processing device of the fourth aspect, the vehicle information is the engine speed. Moreover, in a case in which the vehicle is in an eco mode in which travel control suitable for eco travel is performed, the control section is configured to widen, in the meter image, the interval of the graduations in the low rotation range of the engine speed to be wider than the interval of the graduations in the high rotation range of the engine speed. This enables the information processing device to increase the visibility of the meter image in the eco mode by widening the interval of the graduations corresponding to the low rotation range which the driver monitors during eco travel.

An information processing device of a fifth aspect is the information processing device of any of the first aspect to the fourth aspect, wherein: in a case in which an interval of graduations of a predetermined portion illustrated in the meter image is widened, the control section is configured to narrow an interval of graduations of another portion in the meter image so as to maintain a display size of the meter image at the display.

In the information processing device of the fifth aspect, in a case in which an interval of the graduations of a predetermined portion illustrated in the meter image is widened, the control section is configured to narrow the interval of the graduations of another portion in the meter image so as to maintain the display size of the meter image at the display. This enables the information processing device to prevent the display size of the meter image from being changed in response to a change in the interval of the graduations, thereby preventing the display content at the display from being troublesome to the driver.

### Effect of the Invention

As described above, the information processing device according to the present disclosure can improve the visibility of a meter image of a meter, displayed at a display, which indicates vehicle information relating to travel control of a vehicle.

### BRIEF DESCRIPTION OF THE DRAWINGS

Exemplary embodiments of the present disclosure will be described in detail based on the following figures, wherein:

FIG. 1 is a block diagram illustrating a hardware configuration of a vehicle.

FIG. 2 is a first display example displayed at a monitor.

FIG. 3 is a flowchart illustrating a flow of specific processing.

FIG. 4 is a second display example displayed at a monitor.

FIG. 5 is a third display example displayed at a monitor.

FIG. 6 is a fourth display example displayed at a monitor.

### MODE FOR IMPLEMENTING THE INVENTION

Explanation follows regarding a vehicle 10 according to the present exemplary embodiment.

### First Exemplary Embodiment

First, explanation follows regarding a first exemplary embodiment of the vehicle 10 according to the present exemplary embodiment.

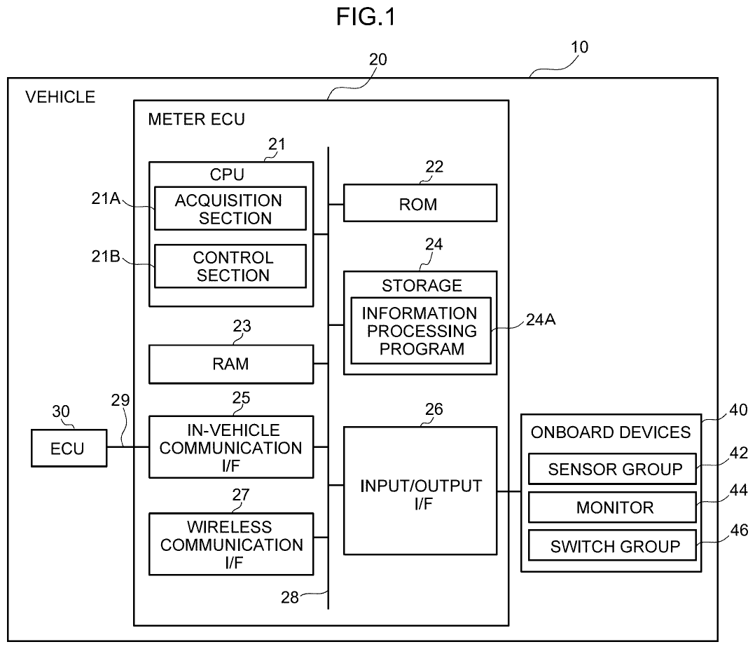

FIG. 1 is a block diagram illustrating a hardware configuration of the vehicle 10. As illustrated in FIG. 1, the vehicle 10 includes a meter electronic control unit (ECU) 20. The meter ECU 20 is an example of an information processing device.

The meter ECU 20 includes a central processing unit (CPU) 21, read only memory (ROM) 22, random access memory (RAM) 23, storage 24, an in-vehicle communication interface (I/F) 25, an input/output I/F 26, and a wireless communication I/F 27. The CPU 21, the ROM 22, the RAM 23, the storage 24, the in-vehicle communication I/F 25, the input/output I/F 26, and the wireless communication I/F 27 are communicably connected to each other via an internal bus 28.

The CPU 21 is a central processing unit that executes various programs and controls various components. Namely, the CPU 21 reads a program from the ROM 22 or the storage 24, and executes the program using the RAM 23 as a workspace. The CPU 21 controls the respective configurations described above and performs a variety of computation processing in accordance with programs stored in the ROM 22 or the storage 24. The CPU 21 is an example of a processor.

The ROM 22 stores various programs and various data. The RAM 23 serves as a workspace to temporarily store programs and data.

The storage 24 is configured by a storage device such as an embedded multimedia card (eMMC) or universal flash storage (UFS), and stores various programs and various data. An information processing program 24A is stored in the storage 24. The information processing program 24A is a program for causing the CPU 21 to execute specific processing (see FIG. 3), which is described below.

The in-vehicle communication I/F 25 is an interface for connecting to another ECU 30. The in-vehicle communication I/F 25 employs a communication protocol based on the CAN protocol. The in-vehicle communication I/F 25 is connected to an external bus 29. Note that although not illustrated in the drawings, plural ECUs are provided for each function of the vehicle 10, in addition to the ECU 30.

The input/output I/F 26 is an interface for communicating with onboard devices 40 that are installed at the vehicle 10.

The onboard devices 40 are various devices installed at the vehicle 10. As examples of the onboard devices 40, the vehicle 10 includes a sensor group 42, a monitor 44, and a switch group 46.

The sensor group 42 includes sensors for detecting states and peripheral states of the vehicle 10, such as a 3D-LiDAR sensor, a millimeter-wave sensor, an infrared sensor, a turn signal sensor, an accelerator opening position sensor, a vehicle speed sensor, a steering angle sensor, an angular velocity sensor, a global positioning system (GPS) sensor, a light intensity sensor, a gyro sensor, and an acceleration sensor. The sensor group 42 outputs the detection results of the respective sensors to the meter ECU 20, the ECU 30, and the like.

The monitor 44 is a liquid crystal monitor which is provided at a meter panel disposed in front of a driver's seat of the vehicle 10 and which displays suggestions for operations relating to functionality of the vehicle 10, in addition to images and the like relating to explanation of the functionality. The monitor 44 is an example of a display.

The switch group 46 includes various switches for, for example, actuating and stopping the functionality of the vehicle 10. The switch group 46 outputs, to the meter ECU 20, the ECU 30, and the like, operation details for the various switches.

The wireless communication I/F 27 is a wireless communication module for communicating with external devices. For example, the wireless communication module uses a communication protocol such as 5G, LTE, Wi-Fi (registered trademark), and Bluetooth (registered trademark).

Moreover, the functional configuration of the CPU 21 of the meter ECU 20 includes an acquisition section 21A and a control section 21B. The respective functional configurations are implemented by the CPU 21 reading and executing the information processing program 24A stored in the storage 24.

The acquisition section 21A acquires various information. For example, the acquisition section 21A acquires various information, such as data input from the ECU 30 via the in-vehicle communication I/F 25, and data input from the sensor group 42 or the switch group 46, via the input/output I/F 26.

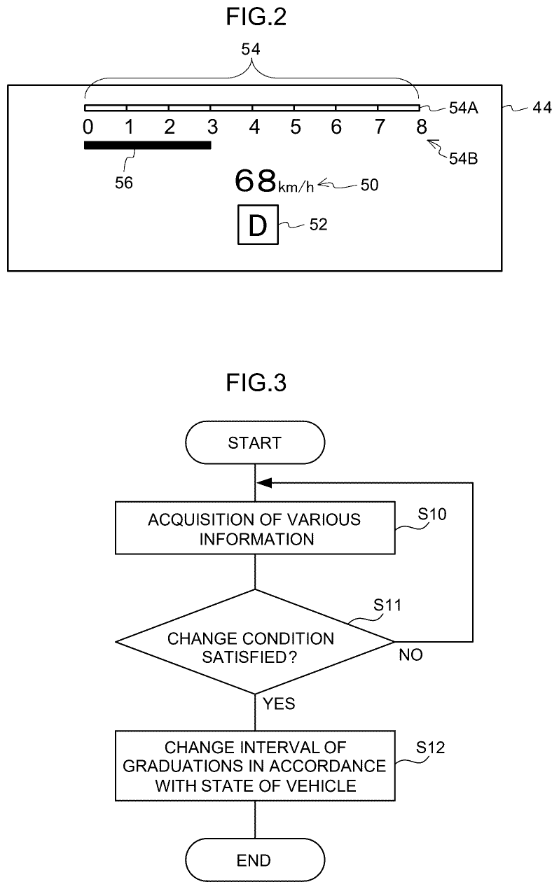

The control section 21B performs display control relating to display at the monitor 44. For example, as the display control, the control section 21B causes display of, at the monitor 44, a meter image 54 (see FIG. 2 and the like) of the meter that indicates vehicle information relating to travel control of the vehicle 10. The vehicle information includes an engine speed, a vehicle speed, and the like.

FIG. 2 is a first display example displayed at the monitor 44. More specifically, FIG. 2 illustrates a display example of the meter image 54 in a case in which the vehicle 10 is in a normal mode.

Note that the vehicle 10 is provided with three travel modes: a normal mode, which is a normal travel mode; an eco mode, which implements eco travel in which fuel efficiency is prioritized over the normal mode; and a sports mode, which enables sports travel, which is more powerful than the normal mode, to be enjoyed. A driver can switch the travel mode by operating predetermined switches included in the switch group 46. In the sports mode, travel control that is suitable for sports travel is performed, and for example, the required torque to the engine, which is based on the accelerator opening position that is detected by an accelerator opening position sensor included in the sensor group 42, is larger than in the normal mode. In the eco mode, travel control that is suitable for eco travel is performed, and for example, the required torque to the engine based on the accelerator opening position is smaller than in the normal mode.

As illustrated in FIG. 2, the monitor 44 displays vehicle speed information 50, shift information 52, the meter image 54, and a gauge 56.

The vehicle speed information 50 indicates a vehicle speed of the vehicle 10. In FIG. 2, 68 km/h is displayed as the vehicle speed information 50, indicating that the vehicle speed is 68 km/h.

The shift information 52 indicates a shift position of the vehicle 10. In FIG. 2, D is displayed as the shift information 52, indicating that the shift position is in the D range.

The meter image 54 is an image of a tachometer, which is a meter that indicates the engine speed. The meter image 54 includes eight graduations 54A and a numerical value 54B indicating an engine speed corresponding to each of the graduations 54A. In the meter image 54, the intervals of the eight graduations 54A are all of equal width.

The gauge 56 is a rectangular figure that expands and contracts in response to changes in the engine speed. FIG. 2 illustrates that the gauge 56 is located near the front end of the fourth graduation 54A from the left, and that the engine speed is approximately 3,000 revolutions per minute.

Note that as a function of the control section 21B, the CPU 21 of the meter ECU 20 changes the interval of the graduations 54A of the tachometer illustrated in the meter image 54 in accordance with the state of the vehicle 10. The state of the vehicle 10 is a concept including a travel mode, a travel location, and the like of the vehicle 10. Explanation follows regarding a flow of the control performed by the meter ECU 20, with reference to FIG. 3.

FIG. 3 is a flowchart illustrating a flow of specific processing executed by the meter ECU 20. The specific processing is performed by the CPU 21 reading the information processing program 24A from the storage 24, and loading and executing the information processing program 24A in the RAM 23. As an example, in a case in which the travel mode of the vehicle 10 is the normal mode, the specific processing is repeatedly and automatically performed each time a predetermined period of time elapses.

At step S10 illustrated in FIG. 3, the CPU 21 acquires various information. The CPU 21 then proceeds to step S11.

At step S11, the CPU 21 determines whether or not a change condition for changing the interval of the graduations 54A of the tachometer illustrated in the meter image 54 has been satisfied. In a case in which the CPU 21 determines that the change condition has been satisfied (step S11: YES), the processing proceeds to step S12. On the other hand, in a case in which the CPU 21 determines that the change condition has not been satisfied (step S11: NO), the processing returns to step S10. In the first exemplary embodiment, the CPU 21 determines that the change condition has been satisfied in a case in which the travel mode has been switched to the eco mode or the sports mode.

At step S12, the CPU 21 changes the interval of the graduations 54A of the tachometer illustrated in the meter image 54 in accordance with the state of the vehicle 10. In the first exemplary embodiment, the CPU 21 changes the meter image 54 such that the intervals of the graduations 54A are in accordance with a case in which the travel mode is the sports mode or the eco mode. The CPU 21 then ends the specifying processing.

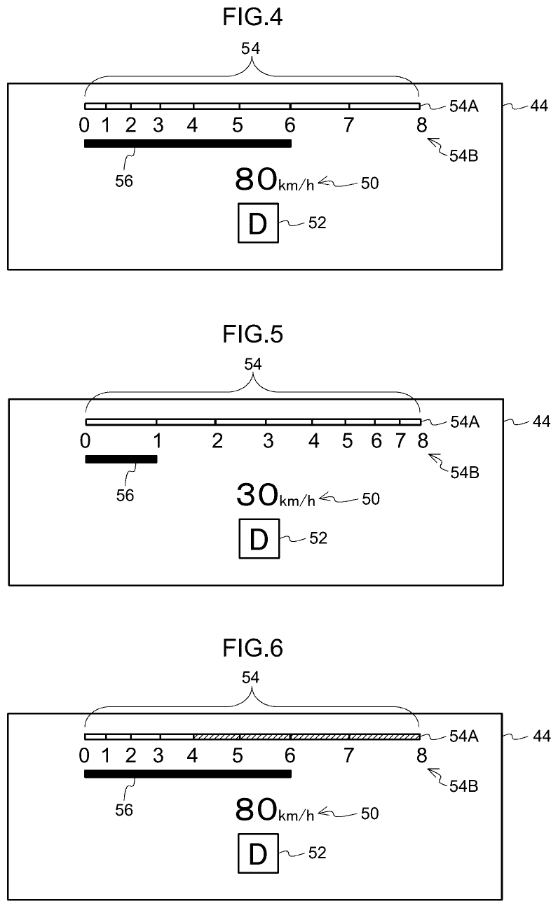

Next, explanation follows regarding an example of changing the interval of the graduations 54A, with reference to FIG. 4 and FIG. 5.

FIG. 4 is a second display example displayed at the monitor 44. More specifically, FIG. 4 illustrates the first display example of the meter image 54 in a case in which the vehicle 10 is in the sports mode.

As illustrated in FIG. 4, the monitor 44 displays the vehicle speed information 50, the shift information 52, the meter image 54, and the gauge 56.

In FIG. 4, 80 km/h is displayed as the vehicle speed information 50, indicating that the vehicle speed is 80 km/h. Further, in FIG. 4, D is displayed as the shift information 52, indicating that the shift position is in the D range. Moreover, FIG. 4 illustrates that the gauge 56 is located near the front end of the seventh graduation 54A from the left, and that the engine speed is approximately 6,000 revolutions per minute.

Note that in the meter image 54 illustrated in FIG. 4, the interval of the graduations 54A corresponding to a high rotation range in which the engine speed is greater than or equal to 4,000 revolutions per minute is wider than the interval of the graduations 54A corresponding to a low rotation range in which the engine speed is less than 4,000 revolutions per minute. As an example, in the meter image 54, the interval of the graduations 54A is wider as the rotation range becomes higher. For example, in the meter image 54, the interval of the sixth graduation 54A from the left indicating from 5,000 revolutions per minute to 6,000 revolutions per minute is wider than the interval of the fifth graduation 54A from the left indicating from 4,000 revolutions per minute to 5,000 revolutions per minute.

FIG. 5 is a third display example displayed at the monitor 44. More specifically, FIG. 5 illustrates a display example of the meter image 54 in a case in which the vehicle 10 is in the eco mode.

As illustrated in FIG. 5, the monitor 44 displays the vehicle speed information 50, the shift information 52, the meter image 54, and the gauge 56.

In FIG. 5, 30 km/h is displayed as the vehicle speed information 50, indicating that the vehicle speed is 30 km/h. Further, in FIG. 5, D is displayed as the shift information 52, indicating that the shift position is in the D range. Moreover, FIG. 5 illustrates that the gauge 56 is located near the front end of the second graduation 54A from the left, and that the engine speed is approximately 1,000 revolutions per minute.

Note that in the meter image 54 illustrated in FIG. 5, the interval of the graduations 54A corresponding to a low rotation range in which the engine speed is less than 4,000 revolutions per minute is wider than the interval of the graduations 54A corresponding to a high rotation range of greater than or equal to 4,000 revolutions per minute. As an example, in the meter image 54, the interval of the graduations 54A is wider as the rotation range becomes lower. For example, in the meter image 54, the interval of the second graduation 54A from the left indicating from 1,000 revolutions per minute to 2,000 revolutions per minute is wider than the graduation of third graduation 54A from the left indicating from 2,000 revolutions per minute to 3,000 revolutions per minute.

As illustrated in FIG. 4 and FIG. 5, in a case in which the interval of the graduations 54A in a predetermined portion illustrated in the meter image 54 is widened, the CPU 21 narrows the interval of the graduations 54 in the other portion, and maintains the display size of the meter image 54 at the monitor 44. For example, in FIG. 4, the CPU 21 narrows the interval of the graduations 54A corresponding to the low rotation range, which is the other portion, by an amount corresponding to the amount that the interval of the graduations 54A corresponding to the high rotation range, which is the predetermined portion, is widened. At this time, the CPU 21 narrows the interval of the graduations 54A as the rotation range becomes lower. For example, in the meter image 54 illustrated in FIG. 4, the interval of the second graduation 54A from the left indicating from 1,000 revolutions per minute to 2,000 revolutions per minute is narrower than the interval of the third graduation 54A from the left indicating from 2,000 revolutions per minute to 3,000 revolutions per minute. As described above, in the meter ECU 20, the CPU 21 causes display of, at the monitor 44, the meter image 54 of the tachometer indicating the engine speed. The CPU 21 then changes the interval of the graduations 54A of the tachometer illustrated in the meter image 54 in accordance with the state of the vehicle 10. This enables the meter ECU 20 to enhance the visibility of the meter image 54 in a specific state by causing display of the graduations 54A at intervals corresponding to the state of the vehicle 10.

Moreover, in the meter ECU 20, as a function of the control section 21B, in a case in which the vehicle 10 is in the sports mode, the CPU 21 widens, in the meter image 54, the interval of the graduations 54A in the high rotation range of the engine speed to be wider than the interval of the graduations 54A in the low rotation range of the engine speed. This enables the meter ECU 20 to increase the visibility of the meter image 54 in the sports mode by widening the interval of the graduations 54A corresponding to the high rotation range which the driver monitors during sports travel.

Moreover, in the meter ECU 20, as a function of the control section 21B, in a case in which the vehicle 10 is in the eco mode, the CPU 21 widens, in the meter image 54, the interval of the graduations 54A in the low rotation range of the engine speed to be wider than the interval of the graduations 54A in the high rotation range of the engine speed. This enables the meter ECU 20 to increase the visibility of the meter image 54 in the eco mode by widening the interval of the graduations 54A corresponding to the low rotation range which the driver monitors during eco travel.

Further, in the meter ECU 20, in a case in which the interval of the graduations 54A in a predetermined portion illustrated in the meter image 54 is widened, the CPU 21 narrows the interval of the graduations 54A in the other portion, and maintains the display size of the meter image 54 at the monitor 44. This enables the meter ECU 20 to prevent the display size of the meter image 54 from being changed in response to a change in the interval of the graduations 54A, thereby preventing the displayed content at the monitor 44 from being troublesome to the driver.

### Second Exemplary Embodiment

Next, explanation follows regarding a second exemplary embodiment of the vehicle 10 according to the present exemplary embodiment, while omitting or simplifying overlapping portions with the above-described exemplary embodiment.

The second exemplary embodiment differs from the above-described exemplary embodiment in the content of the determination as to whether or not a change condition has been satisfied in the specific processing illustrated in FIG. 3. More specifically, at step S11 illustrated in FIG. 3, in a case in which the travel mode has been switched to the eco mode or the sports mode, or in a case in which the current position of the vehicle 10 measured by the GPS sensor included in the sensor group 42 belongs to a specific location, the CPU 21 determines that the change condition has been satisfied. A specific location is, for example, a location at which motor sports take place, such as a racing circuit or a rally course which enable sports travel in which a vehicle speed at which a speed limiter of the vehicle 10 operates is increased.

Moreover, as a function of the control section 21B, in a case in which the vehicle 10 is located at a specific location at which sports travel is possible, the CPU 21 widens, in the meter image 54, the interval of the graduations 54A in the high rotation range of the engine speed to be wider than the interval of the graduations 54A in the low rotation range of the engine speed (see FIG. 4). This enables the meter ECU 20 to improve the visibility of the meter image 54 at a specific location by automatically widening the interval of the graduations 54A corresponding to the high rotation range in response to the intention of the driver.

### OTHER EXEMPLARY EMBODIMENTS

In the above-described exemplary embodiments, the CPU 21 may increase the visibility of the graduations 54A with a widened interval by making the display content of the graduations 54A with a widened interval different from the display content of the graduations 54A with a narrowed interval. Explanation follows with reference to FIG. 6.

FIG. 6 is a fourth display example displayed at the monitor 44. More specifically, FIG. 6 illustrates the second display example of the meter image 54 in a case in which the vehicle 10 is in the sports mode.

Similarly to the above-described exemplary embodiments, in the meter image 54 illustrated in FIG. 6, the interval of the graduations 54A corresponding to the high rotation range in which the engine speed is greater than or equal to 4,000 revolutions per minute is wider than the interval of the graduations 54A corresponding to the low rotation range in which the engine speed is less than 4,000 revolutions per minute. Note that in the meter image 54, the graduations 54A corresponding to the high rotation range are hatched with diagonal lines, and the graduations 54A corresponding to the low rotation range are blank. In this manner, the CPU 21 may highlight the graduations 54A with a widened interval by hatching only the graduations 54A with a widened interval to improve visibility. Note that the method of highlighting is not limited to a difference in design applied to the graduations 54A, and may be a difference in color or the like of the graduations 54A.

Although the monitor 44 is an example of a display in the above-described exemplary embodiments, an example of the display is not thereto. For example, an example of the display may be a multimedia display provided at an upper side of a center console, or a head-up display (HUD). In a case in which an example of the display is another display that is different from the monitor 44, an example of the information processing device is an ECU that controls the other display.

Although the tachometer is an example of a meter in the above-described exemplary embodiments, an example of the meter is not limited thereto. For example, an example of the meter may be a speedometer that indicates vehicle speed. In this case, the meter image is an image of a speedometer indicating the vehicle speed.

In the above-described exemplary embodiments, although the engine speed is set to a high rotation range of greater than or equal to 4,000 revolutions per minute and a low rotation range of less than 4,000 revolutions per minute, a boundary between the high rotation range and the low rotation range is not limited thereto, and any numerical value can be set.

In the above-described exemplary embodiments, although the interval of the graduations 54A in the meter image 54 is wider as the rotation range is higher, and the interval of the graduations 54A is narrower as the rotation range is lower, there is no limitation thereto. For example, in the meter image 54, the interval of the graduations 54A in the high rotation range may be a uniform width which is a wider interval than the low rotation range, and the interval of the graduations 54A in the low rotation range may be a uniform width which is a narrower interval than the high rotation range.

In the above-described exemplary embodiments, in order to change the driving performance of the vehicle 10, for example, in a case in which the CPU 21 receives a predetermined input to increase the vehicle speed at which the speed limiter of the vehicle 10 operates, the CPU 21 may determine that the change condition has been satisfied. In this case, based on the change condition being satisfied, the CPU 21 may widen the interval of the graduations 54A, in the meter image 54, which correspond to the high rotation range of the engine speed.

Although the design of the meter image 54 is common regardless of the travel mode of the vehicle 10 in the above-described exemplary embodiments, the design of the meter image 54 may be different for each travel mode. For example, the shape of the graduations 54A may be different for each travel mode or the color of the graduations 54A may be different for each travel mode. Similarly, the design of the gauge 56 may be different for each travel mode. For example, the shape of the gauge 56 may be different for each travel mode or the color of the gauge 56 may be different for each travel mode.

Although the number of graduations 54A is common regardless of the travel mode of the vehicle 10 in the above-described exemplary embodiments, there is no limitation thereto, and the number of graduations 54A may be different for each travel mode.

In the above-described exemplary embodiments, in a case in which the interval of the graduations 54A in a predetermined portion illustrated in the meter image 54 is widened, the interval of the graduations 54A in all of the remaining portions is narrowed; however, there is no limitation thereto. For example, in a case in which the interval of the graduations 54A in a predetermined portion is widened in the meter image 54, there may be another specific portion of the graduations 54A in which the interval of the graduations 54A is not narrowed.

Note that the specific processing executed by the CPU 21 reading and executing software (a program) in the above-described exemplary embodiments may be executed by any of various types of processors other than a CPU. Examples of such processors include a Programmable Logic Device (PLD) in which the circuit configuration can be modified post-manufacture, such as a Field-Programmable Gate Array (FPGA), or a specialized electric circuit that is a processor with a specifically-designed circuit configuration for executing specific processing, such as an Application Specific Integrated Circuit (ASIC). Further, the specific processing may be executed by one of these various types of processors, or may be executed by combining two or more of the same type or different types of processors (for example, plural FPGAs, or a combination of a CPU and an FPGA, or the like). Moreover, a hardware configuration of the various processors is specifically formed as an electric circuit combining circuit elements such as semiconductor elements.

In addition, although explanation has been given regarding an aspect in which the information processing program 24A is stored (installed) in advance in the storage 24 in the above-described exemplary embodiments, there is no limitation thereto. The information processing program 24A may be provided in a format recorded on a recording medium such as compact disc read only memory (CD-ROM), digital versatile disc read only memory (DVD-ROM), or universal serial bus (USB) memory. Alternatively, the information processing program 24A may be provided in a format downloadable from an external device via a network.

What is claimed is:

1. An information processing device, comprising:
a processor configured to:
cause a display to display a meter image of a meter that indicates vehicle information relating to travel control of a vehicle; and
change an interval of graduations of the meter illustrated in the meter image, in accordance with a state of the vehicle.

2. The information processing device according to claim 1, wherein:
the vehicle information is an engine speed; and
in a case in which the vehicle is in a sports mode in which travel control suitable for sports travel is performed, the processor is configured to, in the meter image, widen an interval of graduations in a high rotation range of the engine speed to be wider than an interval of graduations in a low rotation range of the engine speed.

3. The information processing device according to claim 1, wherein:
the vehicle information is an engine speed; and
in a case in which the vehicle is located at a specific location at which sports travel is possible, the processor is configured to, in the meter image, widen an interval of graduations in a high rotation range of the engine speed to be wider than an interval of graduations in a low rotation range of the engine speed.

4. The information processing device according to claim 1, wherein:
the vehicle information is an engine speed; and
in a case in which the vehicle is in an eco mode in which travel control suitable for eco travel is performed, the processor is configured to, in the meter image, widen an interval of graduations in a low rotation range of the engine speed to be wider than an interval of graduations in a high rotation range of the engine speed.

5. The information processing device according to claim 1, wherein:
in a case in which an interval of graduations of a predetermined portion illustrated in the meter image is widened, the processor is configured to narrow an interval of graduations of another portion in the meter image so as to maintain a display size of the meter image at the display.
